(19) United States
(12) Patent Application Publication
(10) Pub. No.: US 2013/0321170 A1
(43) Pub. Date: Dec. 5, 2013

(54) PRESENTATION CONTROL DEVICE, PRESENTATION CONTROL METHOD, PROGRAM, STORAGE MEDIUM AND POSITION ACQUISITION DEVICE

(71) Applicant: SONY CORPORATION, Tokyo (JP)

(72) Inventor: IZUMI URANO, Tokyo (JP)

(73) Assignee: SONY CORPORATION, Tokyo (JP)

(21) Appl. No.: 13/875,564

(22) Filed: May 2, 2013

(30) Foreign Application Priority Data
May 29, 2012 (JP) 2012-121556

(51) Int. Cl. G08G 1/0967

(52) U.S. Cl. CPC G08G 1/0967
USPC 340/905

(57) ABSTRACT

There is provided a presentation control device including an extraction portion that extracts a road segment having a similar gradient to a target road segment based on a travel history of a user, and a presentation control portion that controls presentation of information indicating the road segment extracted by the extraction portion.

### BACKGROUND

The present disclosure relates to a presentation control device, a presentation control method, a program, a storage medium and a position acquisition device.

In recent years, a navigation system, which guides a user to a destination, is being used in a variety of situations. For example, the navigation system is installed in a variety of modes of transport, such as an automobile, a bicycle and so on. Further, the navigation system is being installed in a mobile terminal, such as a smart phone, and can be used, for example, by a user who is moving on foot. It is conceivable that, if the user using such a navigation system is able to ascertain in advance, for example, a gradient of a road along which the user plans to travel, it would be possible to enhance the convenience to the user.

Technology has been disclosed, for example, in which gradients for each of a plurality of routes are ranked based on the gradients of each of the plurality of routes, and the plurality of routes are displayed in an order of ranking (see Japanese Patent Application Publication No. JP-A-2011-112479, for example). With this technology, it is possible to ascertain information relating to the gradient of each of the plurality of routes (a rank of each route and a gradient of each route, for example). Further, it is possible to ascertain, using a similar method, information relating to gradients of road segments that form the route.

### SUMMARY

However, with this technology, it is difficult for a user to easily get a real feel for an extent of a gradient of a road segment. It is thus desirable to realize a technology that allows an extent of gradient of the road segment to be readily ascertained with an actual feel for the gradient.

According to an embodiment of the present disclosure, there is provided a presentation control device including an extraction portion that extracts a road segment having a similar gradient to a target road segment based on a travel history of a user, and a presentation control portion that controls presentation of information indicating the road segment extracted by the extraction portion.

According to an embodiment of the present disclosure, there is provided a presentation control method including extracting a road segment having a similar gradient to a target road segment based on a travel history of a user, and controlling presentation of information indicating the extracted road segment.

According to an embodiment of the present disclosure, there is provided a program for causing a computer to function as a presentation control device including an extraction portion that extracts a road segment having a similar gradient to a target road segment based on a travel history of a user, and a presentation control portion that controls presentation of information indicating the road segment extracted by the extraction portion.

According to an embodiment of the present disclosure, there is provided a computer-readable storage medium storing a program for causing a computer to function as a presentation control device including an extraction portion that extracts a road segment having a similar gradient to a target road segment based on a travel history of a user, and a presentation control portion that controls presentation of information indicating the road segment extracted by the extraction portion.

According to an embodiment of the present disclosure, there is provided a position acquisition device including a position acquisition portion that acquires a current position of a user. A road segment having a similar gradient to a target road segment is extracted based on the current position and on a travel history of the user, and presentation of information indicating the extracted road segment is controlled.

According to the present disclosure as described above, it is possible to provide a technology that allows an extent of gradient of a road segment to be easily ascertained with an actual feel for the gradient.

### BRIEF DESCRIPTION OF THE DRAWINGS

FIG. 1 is a diagram showing an example of an appearance of a presentation control device according to an embodiment of the present disclosure;

FIG. 2 is a diagram showing an example of a functional configuration of a presentation control device according to a first embodiment of the present disclosure;

FIG. 3 is a diagram showing an example of a configuration of road information that is used by the presentation control device according to the first embodiment of the present disclosure;

FIG. 4 is a diagram showing an example of a configuration of a user travel history that is used by the presentation control device according to the first embodiment of the present disclosure;

FIG. 5 is a diagram showing an example of functions of the presentation control device according to the first embodiment of the present disclosure;

FIG. 6 is a diagram showing an example of a display result due to control by the presentation control device according to the first embodiment of the present disclosure;

FIG. 7 is a diagram showing an example of a functional configuration of a presentation control device according to a second embodiment of the present disclosure;

FIG. 8 is a diagram showing an example of functions of the presentation control device according to the second embodiment of the present disclosure;

FIG. 9 is a diagram showing an example of a display result due to control by the presentation control device according to the second embodiment of the present disclosure;

FIG. 10 is a diagram showing an example of a functional configuration of a presentation control device according to a third embodiment of the present disclosure;

FIG. 11 is a diagram showing an example of functions of the presentation control device according to the third embodiment of the present disclosure; and

FIG. 12 is a diagram showing an example of a display result due to control by the presentation control device according to the third embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in the present specification and appended drawings, a plurality of structural elements that have a same functional configuration in actuality are sometimes distinguished using a different alphabetic symbol after a same reference number. However, in cases where it is not particularly necessary to distinguish between each of the plurality of structural elements that have the same functional configuration in actuality, only the same reference numeral is assigned.

Note that the preferred embodiments of the present disclosure will be explained in the order shown below:

1. Example of appearance of presentation control device

2. First embodiment
2.1 Example of functional configuration of presentation control device
2.2 Example of configuration of road information
2.3 Example of configuration of user travel history
2.4 Example of functions of presentation control device

3. Second embodiment
3.1 Example of functional configuration of presentation control device
3.2 Example of functions of presentation control device

4. Third embodiment
4.1 Example of functional configuration of presentation control device
4.2 Example of functions of presentation control device

5. Conclusion

### 1. Example of Appearance of Presentation Control Device

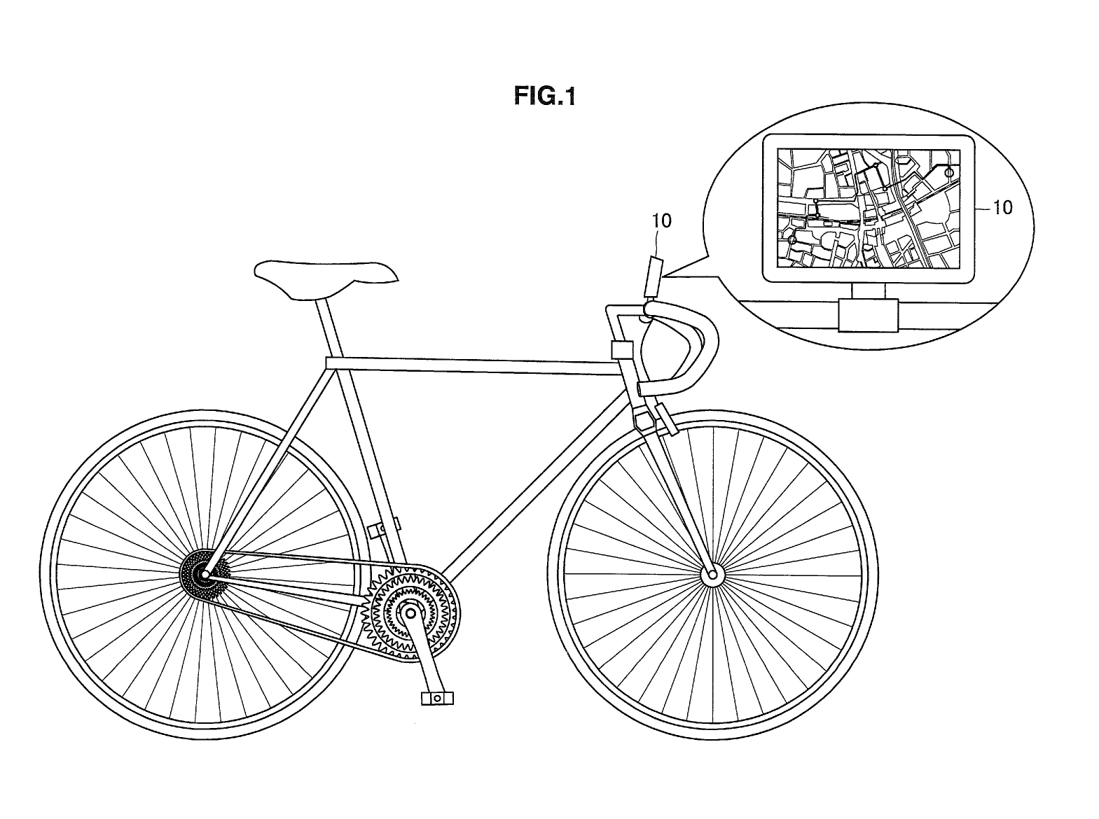

First, an example of an appearance of a presentation control device 10 according to an embodiment of the present disclosure will be explained. FIG. 1 is a diagram showing the example of the appearance of the presentation control device 10 according to the embodiment of the present disclosure.

As shown in FIG. 1, as an example, the presentation control device 10 according to the embodiment of the present disclosure is attached to a bicycle. However, the appearance of the presentation control device 10 shown in FIG. 1 is simply an example. The presentation control device 10 may be attached to an automobile, for example, or may be attached to another mode of transport. Further, the presentation control device 10 may be installed in a mobile terminal, such as a smart phone. The mobile terminal can also be used by a user who is moving on foot, for example.

Here, as described above, it is assumed that if the user can ascertain in advance a gradient of a road along which the user plans to travel, convenience for the user can be improved. For example, as described above, the technology exists by which gradients for each of a plurality of routes are ranked based on the gradients of each of the plurality of routes, and the plurality of routes are displayed in an order of ranking. According to this technology, it is possible to ascertain in advance information relating to the gradient of each of the plurality of routes (a rank of each route and a gradient of each route, for example). Further, it is possible to ascertain, using a similar method, information relating to gradients of road segments that form a route.

However, with this technology, it is difficult to readily ascertain an extent of gradient of the road segment with a real feel for the gradient. For example, even if information is obtained indicating that the gradient of a road segment is “15 degrees,” it is assumed to be difficult to get a real feel for the extent of the gradient. In the embodiment of the present disclosure, therefore, technology is proposed which allows a user to easily get a real feel for an extent of a gradient of a road segment.

The example of the appearance of the presentation control device 10 according to the embodiment of the present disclosure is explained above.

### 2. First embodiment

Next, a first embodiment of the present disclosure will be explained in order in detail.

### 2.1 Example of Functional Configuration of Presentation Control Device

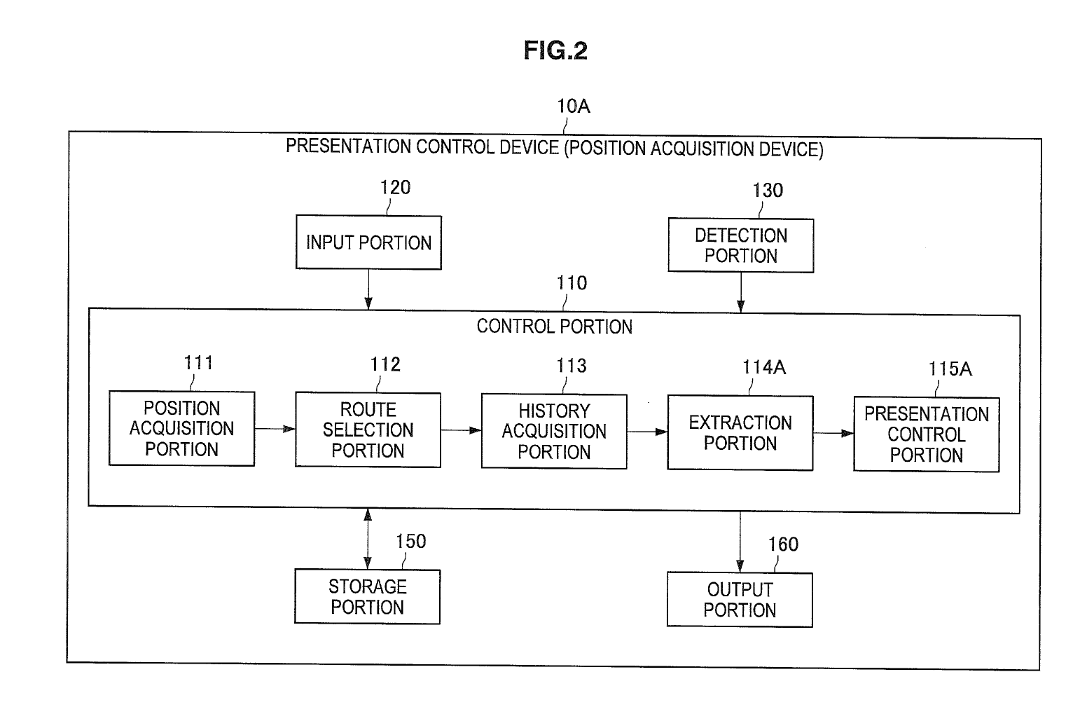

First, a presentation control device 10A according to the first embodiment of the present disclosure will be explained. FIG. 2 is a diagram showing an example of a functional configuration of the presentation control device 10A according to the first embodiment of the present disclosure. As shown in FIG. 2, the presentation control device 10A is provided with a control portion 110, an input portion 120, a detection portion 130, a storage portion 150 and an output portion 160.

The control portion 110 is, for example, a processor such as a central processing unit (CPU). The control portion 110 performs a variety of functions of the control portion 110, by executing programs stored in the storage portion 150 or in another storage medium. Further, the control portion 110 is provided with a position acquisition portion 111, a route selection portion 112, a history acquisition portion 113, an extraction portion 114A and a presentation control portion 115A. Functions of the history acquisition portion 113, the position acquisition portion 111, the route selection portion 112, the extraction portion 114A and the presentation control portion 115A will each be explained in detail later.

The input portion 120 has a function to receive an operation from a user. The input portion 120 outputs the operation from the user to the control portion 110 as operation information. The operation information is used by the control portion 110 to execute the programs, for example. Note that, in the example shown in FIG. 2, the input portion 120 is integrated with the presentation control device 10A, but the input portion 120 may be configured as a separate unit from the presentation control device 10A.

The detection portion 130 has a function to detect a current position of the user. A detection method used by the detection portion 130 to detect the current position of the user is not particularly limited. For example, the detection portion 130 may detect the current position of the user by estimating the current position of the detection portion 130 based on a signal received from a GPS satellite. Further, the current position of the detection portion 130 does not have to be estimated by the detection portion 130.

For example, when a reception result of a signal from a GPS satellite by the detection portion 130 is transmitted to a position estimation server from the presentation control device 10A, the current position of the detection portion 130 may be estimated by the position estimation server. In this case, the detection portion 130 can detect the current position of the detection portion 130 that is estimated by the position estimation server. A format of the current position of the user may be a format that uses longitude and latitude, may be a format that uses polar coordinates, or may be a format that uses vectors. Further, the format of the current position of the user may be three-dimensional coordinates that include altitude.

The storage portion 150 stores programs for causing the control portion 110 to operate, using a storage medium such as a semi-conductor memory, a hard disk or the like. Further, for example, the storage portion 150 can store various data (such as road information, a user travel history and the like) that are used by the programs. These data will be explained in detail later. It should be noted that in the example shown in FIG. 2, the storage portion 150 is integrated with the presentation control device 10A, but the storage portion 150 may be configured as a separate unit from the presentation control device 10A.

The output portion 160 has a function that performs output in accordance with a control by the control portion 110. For example, the output portion 160 has a function to present information to the user in accordance with a control by the control portion 110. The output portion 160 may be a display device that has a function to display a screen, or may be an audio output device that outputs audio to the user. Note that, in the example shown in FIG. 2, the output portion 160 is integrated with the presentation control device 10A, but the output portion 160 may be configured as a separate unit from the presentation control device 10A.

The example of the functional configuration of the presentation control device 10A according to the first embodiment of the present disclosure is explained above.

### 2.2 Example of Configuration of Road Information

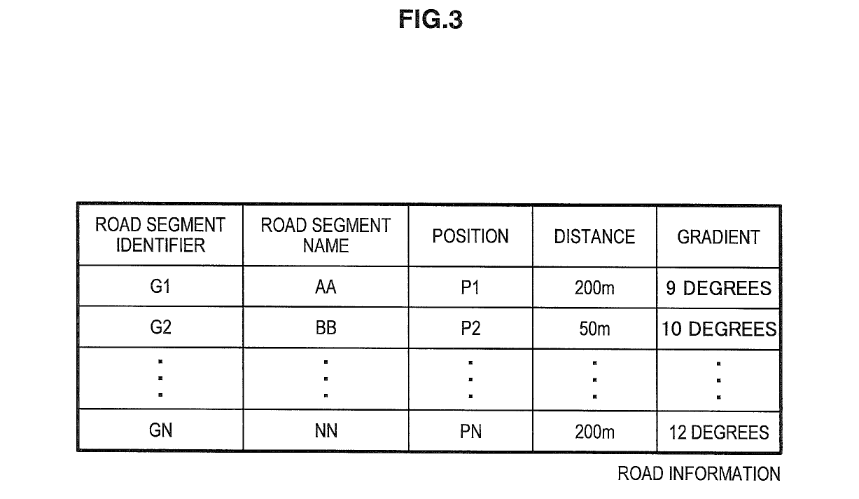

Next, an example of a configuration of road information used by the presentation control device 10A according to the first embodiment of the present disclosure will be explained. FIG. 3 is a diagram showing an example of the configuration of the road information used by the presentation control device 10A according to the first embodiment of the present disclosure. As shown in FIG. 3, the road information includes a road segment identifier, a road segment name, a position, a distance and a gradient. The road segment refers to each segment that is obtained when a road is divided into one or a plurality of segments, and can form a route from a place of departure to a destination of the user.

The road segment identifier that is included in the road information is an identifier that identifies a road segment, and can correspond to an example of information indicating the road segment. The road segment name included in the road information is a name of the road segment and can correspond to an example of information indicating the road segment. Thus, the information representing the road segment is not limited to the road segment identifier and the road segment name.

The position that is included in the road information corresponds to a position of the road segment. A format of the position included in the road information may be a format that uses longitude and latitude, may be a format that uses polar coordinates, or may be a format that uses vectors. Further, the format of the position included in the road information may be three-dimensional coordinates that include altitude. When the road segment passes through one or a plurality of points, the position included in the road information may be indicated, for example, by a position of each of the one or the plurality of points.

The distance included in the road information corresponds to a distance of the road segment. The distance of the road segment may be a distance of the road segment in the horizontal direction, or may be a length of a road surface of the road segment. It should be noted that, in FIG. 3, a case is shown in which a unit of distance of the road segment is “meters (m),” but the unit of distance of the road segment is not limited to “meters (m).” Further, in the example shown in FIG. 3, the distance is included in the road information, but the distance may not be included in the road information.

The gradient that is included in the road information corresponds to a gradient of the road segment. In the example shown in FIG. 3, the gradient of the road segment is expressed, for example, by a ratio of a distance in the vertical direction of the road segment with respect to a distance in the horizontal direction. Note that, in FIG. 3, a case is shown in which the unit of gradient of the road segment is “degrees,” but the unit of gradient of the road segment is not limited to “degrees.” For example, the gradient of the road segment may be a value that expresses the above-described ratio as a percentage “%.”

The example of the configuration of the road information used by the presentation control device 10A according to the first embodiment of the present disclosure is explained above. Note that the above-described road information may be stored in advance in the storage portion 150, for example, and may be acquired from the storage portion 150 as necessary by the control portion 110. Alternatively, the above-described road information may be stored in advance in another device that is separate to the presentation control device 10 and may be received from the other device as necessary by the control portion 110.

### 2.3 Example of Configuration of User Travel History

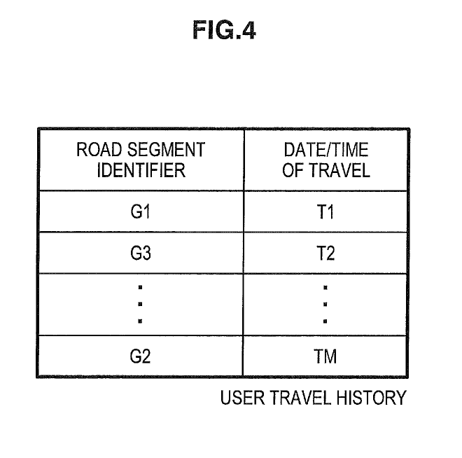

Next, an example of a configuration of a user travel history that is used by the presentation control device 10A according to the first embodiment of the present disclosure will be explained. FIG. 4 is a diagram showing the example of the configuration of the user travel history that is used by the presentation control device 10A according to the first embodiment of the present disclosure. As shown in FIG. 4, the user travel history includes the road segment identifier and a date/time of travel. Similarly to the case shown in FIG. 3, the road segment identifier included in the user travel history is an identifier that identifies the road segment and can correspond to an example of information indicating the road segment.

The date/time of travel corresponds to a date and time at which the user traveled along the road segment. Note that, in the example shown in FIG. 4, the user travel history includes the date/time of travel, but a date of travel may be included in place of the date/time of travel. Further, in the example shown in FIG. 4, the user travel history includes the date/time of travel, but the date/time of travel may not be included in the user travel history and the date of travel may not be included. Further, a travel frequency may be included in the user travel history in place of the date/time of travel.

It should be noted that the user travel history can be generated by the control portion 110 registering information in which the identifier that identifies the road segment being traveled by the user is associated with the current time. In this case, for example, based on the current position of the user detected by the detection portion 130 and on the road information, it is possible to specify the identifier that identifies the road segment currently being traveled by the user as the road segment identifier. The registration may be performed at a specified time interval. Further, only identifiers may be registered that identify road segments having a gradient higher than a specific upper threshold or having a gradient lower than a specific lower threshold. The current time can be acquired from a clock that is outside or inside the presentation control device 10, for example.

The example of the configuration of the user travel history that is used by the presentation control device 10A according to the first embodiment of the present disclosure is explained above. Note that, as described above, the user travel history may be generated by the control portion 110 and stored in advance in the storage portion 150, and may be acquired from the storage portion 150 as necessary by the control portion 110. Alternatively, for example, the user travel history may be stored in advance in another device that is separate to the presentation control device 10, and may be received from the other device by the control portion 110 as necessary.

### 2.4 Example of Functions of Presentation Control Device

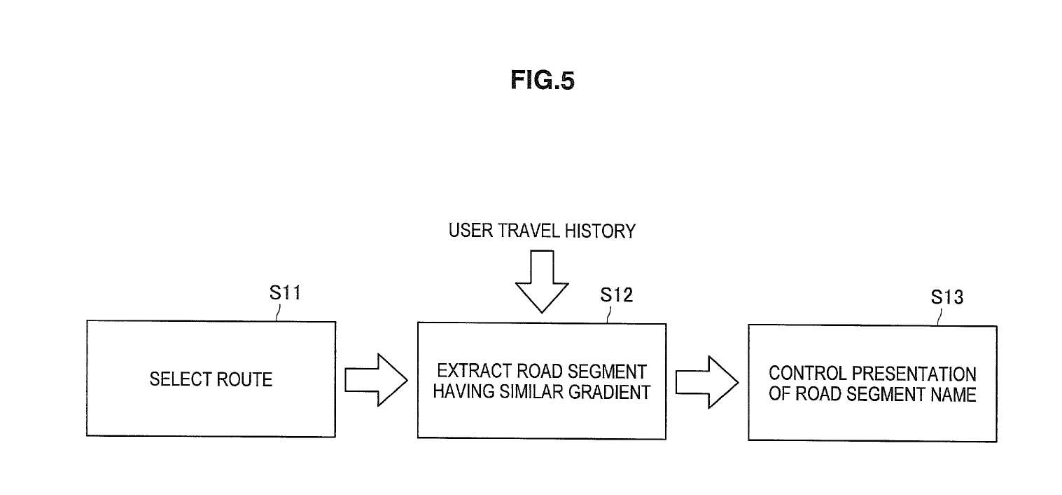

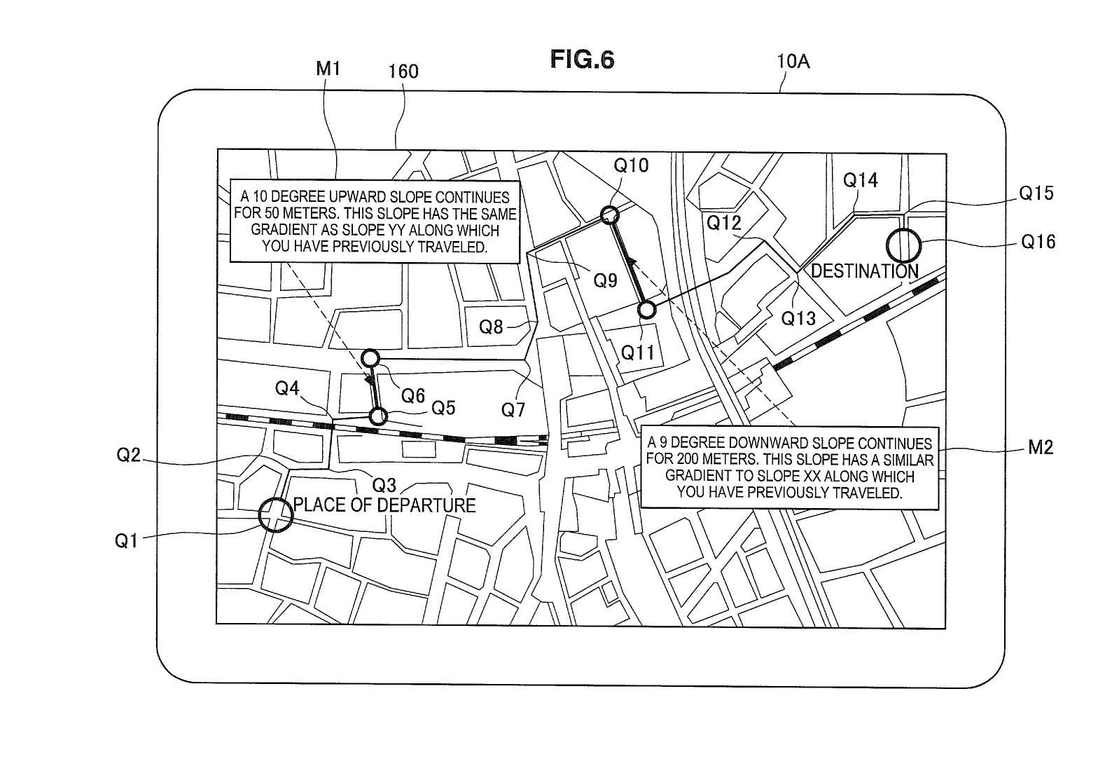

Next, an example of functions of the presentation control device 10A according to the first embodiment of the present disclosure will be explained. FIG. 5 is a diagram showing an example of functions of the presentation control device 10A according to the first embodiment of the present disclosure. FIG. 6 is a diagram showing an example of a display result due to control by the presentation control device 10 according to the first embodiment of the present disclosure.

As shown in FIG. 5, first, the route selection portion 112 selects a route from among one or a plurality of routes (step S11). For example, the route selected by the route selection portion 112 may be a shortest route. Here, each of the one or the plurality of routes is formed from one or a plurality of road segments that exist from the place of departure to the destination of the user, as described above. The one or the plurality of road segments are sequentially connected from the place of departure to the destination. When the plurality of road segments pass through a same point, for example, it is ascertained that the plurality of road segments are connected at that point.

The place of departure and the destination may be specified by an operation by the user, for example. Further, the place of departure may be the current position that is acquired by the position acquisition portion 111. The current position detected by the detection portion 130 may be used as the current position acquired by the position acquisition portion 111.

Note that, in the example shown in FIG. 6, the place of departure is denoted by a point Q1 and the destination is denoted by a point Q16. Further, in the example shown in FIG. 6, a route that is formed of a first road segment (from the point Q1 to a point Q2), a second road segment (from the point Q2 to a point Q3) and so on up to a fifteenth road segment (from a point Q15 to a point Q16), is selected by the route selection portion 112.

Next, the history acquisition portion 113 acquires the user travel history. Further, based on the user travel history, the extraction portion 114A extracts a road segment having a similar gradient to a target road segment (step S12). Here, a case is explained in which each of the road segments that form the route selected by the route selection portion 112 is the target road segment, but the target road segment is not limited to this example. The target road segment may be directly specified by an operation by the user, for example.

Here, a case in which there is a similar gradient may include a case in which the gradient is the same. Further, a range of similarity of the gradients may be established in advance. For example, it may be established in advance that a search target road segment is within the range of similarity when the following conditions are satisfied:

Gradient of target road segment (degrees)−a (degrees)<gradient of search target road segment (degrees)<gradient of target road segment (degrees)+a (degrees) (where a=1, for example).

Alternatively, for example, it may be established in advance that the search target road segment is within the range of similarity when the following conditions are satisfied:

Gradient of target road segment (degrees)−a (degrees)≦gradient of search target road segment (degrees)≦gradient of target road segment (degrees)+a (degrees) (where a=1, for example).

In addition, for example, it may be established in advance that the search target road segment is within the range of similarity when the following conditions are satisfied:

Gradient of target road segment (%)−b (%)≦gradient of search target road segment (%)≦gradient of target road segment (%)+b (%) (where b=1 or 2, for example).

Alternatively, for example, it may be established in advance that the search target road segment is within the range of similarity when the following conditions are satisfied:

Gradient of target road segment (%)−b (%)≦gradient of search target road segment (%)≦gradient of target road segment (%)+b (degrees) (where b=1 or 2, for example).

It should be noted that the gradient of the search target road segment may be the gradient of a road segment that is identified by road segment identification information included in the user travel history, for example.

Next, the presentation control portion 115A controls presentation of information indicating the road segment extracted by the extraction portion 114A. For example, the presentation control portion 115A controls the presentation of the road segment name corresponding to the name of the road segment (step S13). However, the information indicating the road segment is not limited to the road segment name. The information indicating the road segment may be the road segment identifier, for example.

In FIG. 6, an example is shown in which the extraction portion 114A extracts, from the user travel history, a road segment having a similar gradient to a fifth road segment (from a point Q5 to a point Q6) and the presentation control portion 115A controls display of a message M1 relating to the extracted road segment that reads: “A 10 degree upward slope continues for 50 meters. This slope has the same gradient as slope YY along which you have previously traveled.” The information “10 degrees,” “50 meters” and “YY” included in the message M1 can be acquired, respectively, from the “gradient,” the “distance” and the “road segment name” included in the road information, for example.

In addition, in FIG. 6, an example is shown in which the extraction portion 114A extracts, from the user travel history, a road segment having a similar gradient to a tenth road segment (from a point Q10 to a point Q11) and the presentation control portion 115A controls display of a message M2 relating to the extracted road segment that reads: “A 9 degree downward slope continues for 200 meters. This slope has a similar gradient to slope XX along which you have previously traveled.” The information “9 degrees,” “200 meters” and “XX” included in the message M2 can be acquired, respectively, from the “gradient,” the “distance” and the “road segment name” included in the road information, for example.

Note that the example above describes a case in which the presentation control of the information indicating the road segment is performed irrespective of a magnitude of the gradient, but the presentation control of the information indicating the road segment may be performed in a specific case only. For example, the presentation control of the information indicating the road segment may be performed when the gradient is higher than a specific upper threshold (when the road segment is a steep upward slope, for example), or when the gradient is lower than a specific lower threshold (when the road segment is a steep downward slope, for example).

According to this presentation control, it is possible to only present the road segment having the similar gradient to the user when the road segment is reasonably steep, and to not present the road segment having the similar gradient to the user when the road segment is reasonably flat.

More specifically, for example, the extraction portion 114A may extract the road segment having the similar gradient to the target road segment when the gradient of the target road segment is higher than the specific upper threshold or is lower than the specific lower threshold. In other words, the extraction portion 114A may not extract the road segment when the gradient of the target road segment is equal to or less than the specific upper threshold. Further, the extraction portion 114A may not extract the road segment when the gradient of the target road segment is equal to or more than the specific lower threshold.

Further, for example, the extraction portion 114A may extract the road segment having the similar gradient to the target road segment when the gradient of the road segment having the similar gradient to the target road segment is higher than the specific upper threshold or is lower than the specific lower threshold. In other words, the extraction portion 114A may not extract the road segment when the gradient of the road segment that is similar to the gradient of the target road segment is equal to or less than the specific upper threshold. Further, the extraction portion 114A may not extract the road segment when the gradient of the road segment that is similar to the gradient of the target road segment is equal to or more than the specific lower threshold.

The example of the functions of the presentation control device 10A according to the first embodiment of the present disclosure is explained above. According to the above-described example of the functions, the extraction portion 114A extracts the road segment that has a similar gradient to that of the target road segment based on the user travel history, and the presentation control portion 115A can control the presentation of the information indicating the road segment extracted by the extraction portion 114A. As a result, it is possible for the user to easily get a real feel for the extent of the gradient of the road segment.

Note that a variety of methods are assumed as a method by which the extraction portion 114A extracts the road segment. For example, the extraction portion 114A can extract the road segment based, additionally, on a distance from a position that is registered in advance. More specifically, the extraction portion 114A may prioritize and extract the road segment having a close distance from the position registered in advance, for example. For example, the extraction portion 114A may extract the road segment having the closest distance from the position registered in advance, for example. A position of the user's house may be registered in advance, for example.

Further, the extraction portion 114A can extract the road segment based, additionally, on a distance from the current position of the user, for example. More specifically, the extraction portion 114A may prioritize and extract the road segment that has a close distance from the current position of the user, for example. For example, the extraction portion 114A may extract the road segment having the closest distance from the current position of the user.

Further, the extraction portion 114A can extract the road segment based, additionally, on a frequency of passage of the user, for example. More specifically, the extraction portion 114A may prioritize and extract the road segment that has a high frequency of passage by the user, for example. For example, the extraction portion 114A may extract the road segment that has the highest frequency of passage by the user. The frequency of passage of the user can be ascertained from the user travel history, for example.

The first embodiment of the present disclosure is explained in detail above.

### 3. Second Embodiment

Next, a second embodiment of the present disclosure will be explained in order in detail.

### 3.1 Example of Functional Configuration of Presentation Control Device

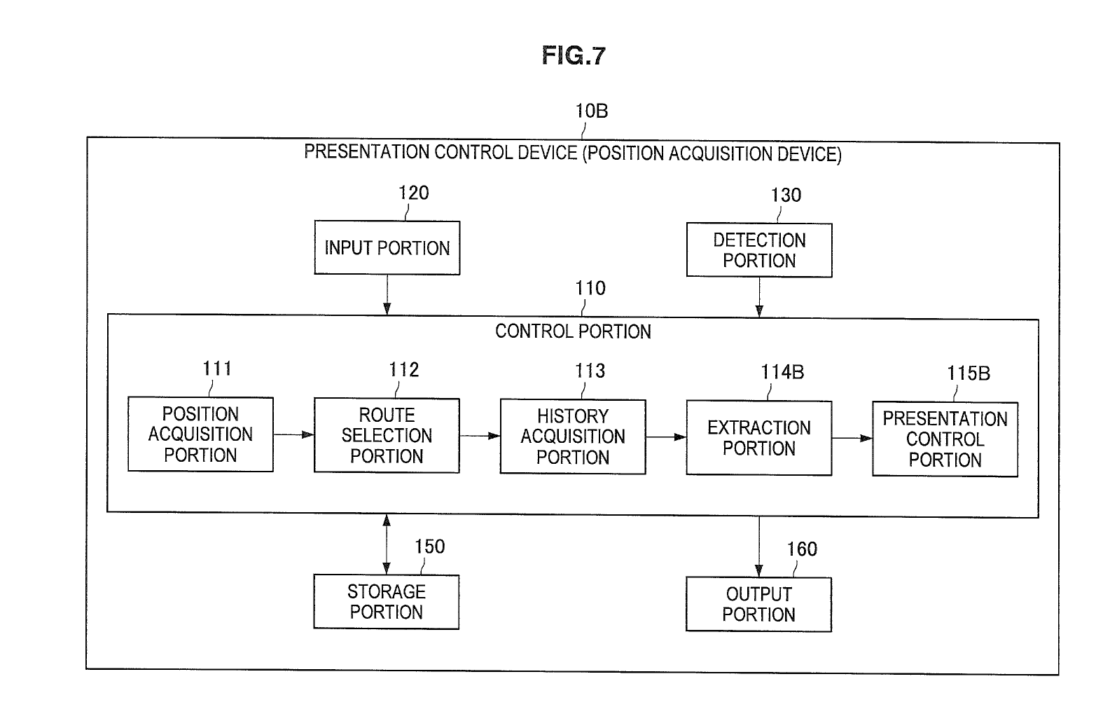

First, an example of a functional configuration of a presentation control device 10B according to the second embodiment of the present disclosure will be explained. FIG. 7 is a diagram showing the example of the functional configuration of the presentation control device 10B according to the second embodiment of the present disclosure. As shown in FIG. 7, the control portion 110 is provided with the history acquisition portion 113, the position acquisition portion 111, the route selection portion 112, an extraction portion 114B and a presentation control portion 115B.

The first embodiment and the second embodiment are mainly different in that functions of the extraction portion 114B are different to the functions of the extraction portion 114A, and functions of the presentation control portion 115B are different to the functions of the presentation control portion 115A. Thus, in the following explanation, examples of the functions of the extraction portion 114B and the presentation control portion 115B will be mainly described.

The example of the functional configuration of the presentation control device 10B according to the second embodiment of the present disclosure is explained above.

### 3.2 Example of Functions of Presentation Control Device

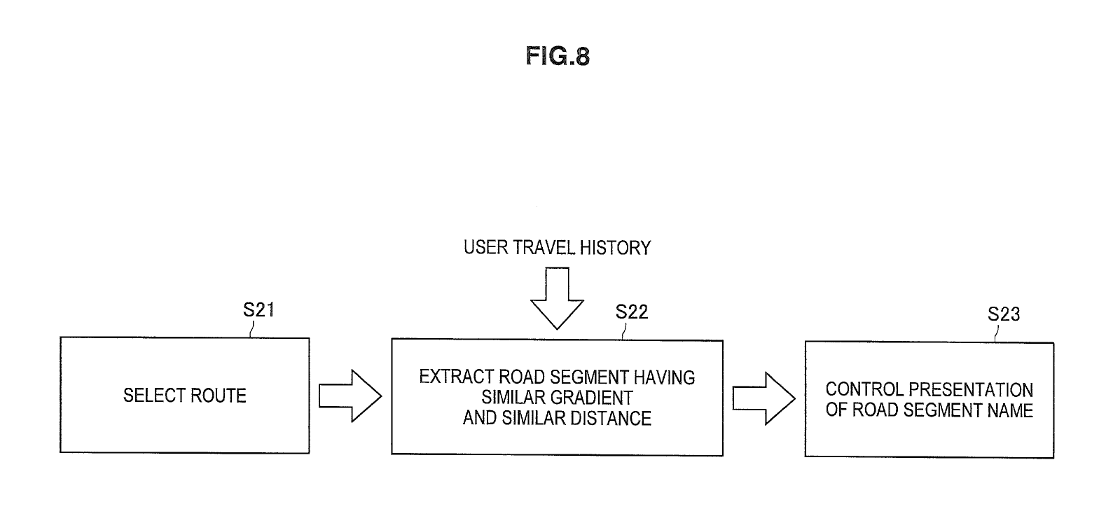

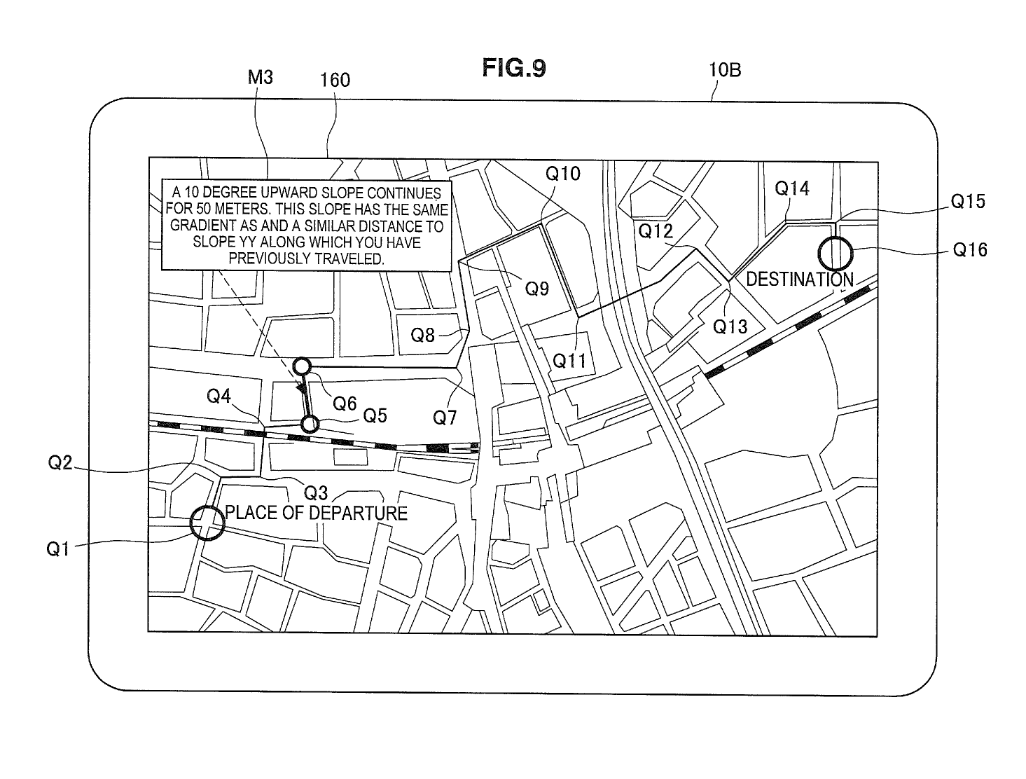

Next, an example of the functions of the presentation control device 10B according to the second embodiment of the present disclosure will be explained. FIG. 8 is a diagram showing the example of the functions of the presentation control device 10B according to the second embodiment of the present disclosure. Further, FIG. 9 is a diagram showing an example of a display result due to control by the presentation control device 10B according to the second embodiment of the present disclosure.

As shown in FIG. 8, first, the route selection portion 112 selects a route from among one or a plurality of routes (step S21). The route selection can be performed similarly to the route selection according to the first embodiment. Next, the history acquisition portion 113 acquires the user travel history and the extraction portion 114B extracts a road segment that, additionally, has a similar distance to the target road segment. For example, the extraction portion 114B extracts the road segment that has a similar gradient to the target road segment and that also has a similar distance to the target road segment (step S22).

Here, a case in which there is a similar distance may include a case in which the distance is the same. Further, a range of similarity of the distances may be established in advance. For example, it may be established in advance that a search target road segment is within the range of similarity when the following conditions are satisfied:

Distance of target road segment−c≦distance of search target road segment≦distance of target road segment+c (where c is a constant).

Alternatively, for example, it may be established in advance that the search target road segment is within the range of similarity when the following conditions are satisfied:

Distance of target road segment−c≦distance of search target road segment≦distance of target road segment+c (where c is a constant).

It should be noted that the distance of the search target road segment may be the distance of a road segment that is identified by the road segment identification information included in the user travel history, for example. Next, the presentation control portion 115B controls presentation of information indicating the road segment extracted by the extraction portion 114B. For example, the presentation control portion 115B controls the presentation of the road segment name corresponding to the name of the road segment (step S23).

In FIG. 9, an example is shown in which the extraction portion 114B extracts, from the user travel history, a road segment having a similar gradient and distance to the fifth road segment (from the point Q5 to the point Q6) and the presentation control portion 115B controls display of a message M3 relating to the extracted road segment that reads: “A 10 degree upward slope continues for 50 meters. This slope has the same gradient as and a similar distance to slope YY along which you have previously traveled.”

The example of the functions of the presentation control device 10B according to the second embodiment of the present disclosure is explained above. According to the example of the functions, the extraction portion 114B extracts the road segment having not only the similar gradient to the target road segment but also having the similar distance, and the presentation control portion 115B can control the presentation of the information indicating the road segment extracted by the extraction portion 114B. As a result, it is possible to easily get a real feel not only for the degree of the gradient of the road segment, but also for the distance of the road segment.

The second embodiment of the present disclosure is explained in detail above.

### 4. Third Embodiment

Next, a third embodiment of the present disclosure will be explained in order in detail.

### 4.1 Example of Functional Configuration of Presentation Control Device

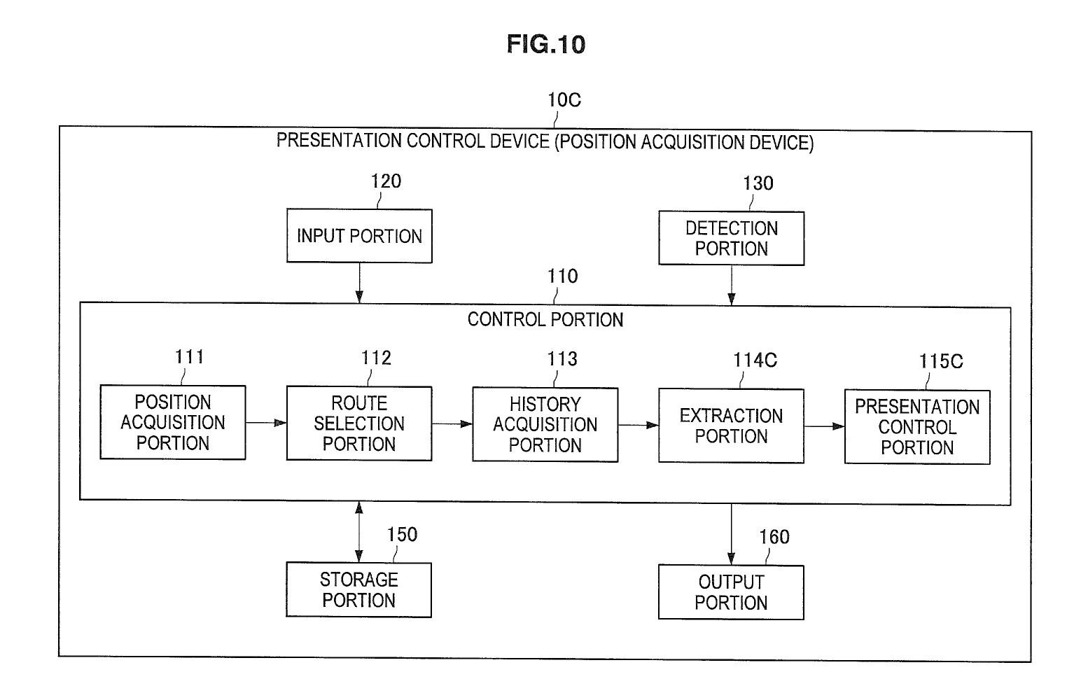

First, an example of a functional configuration of a presentation control device 10C according to the third embodiment of the present disclosure will be explained. FIG. 10 is a diagram showing the example of the functional configuration of the presentation control device 10C according to the third embodiment of the present disclosure. As shown in FIG. 10, the control portion 110 is provided with the history acquisition portion 113, the position acquisition portion 111, the route selection portion 112, an extraction portion 114C and a presentation control portion 115C.

The first embodiment and the third embodiment are mainly different in that functions of the extraction portion 114C are different to the functions of the extraction portion 114A, and functions of the presentation control portion 115C are different to the functions of the presentation control portion 115A. Thus, in the following explanation, examples of the functions of the extraction portion 114C and the presentation control portion 115C will be mainly described.

The example of the functional configuration of the presentation control device 10C according to the third embodiment of the present disclosure is explained above.

### 4.2 Example of Functions of Presentation Control Device

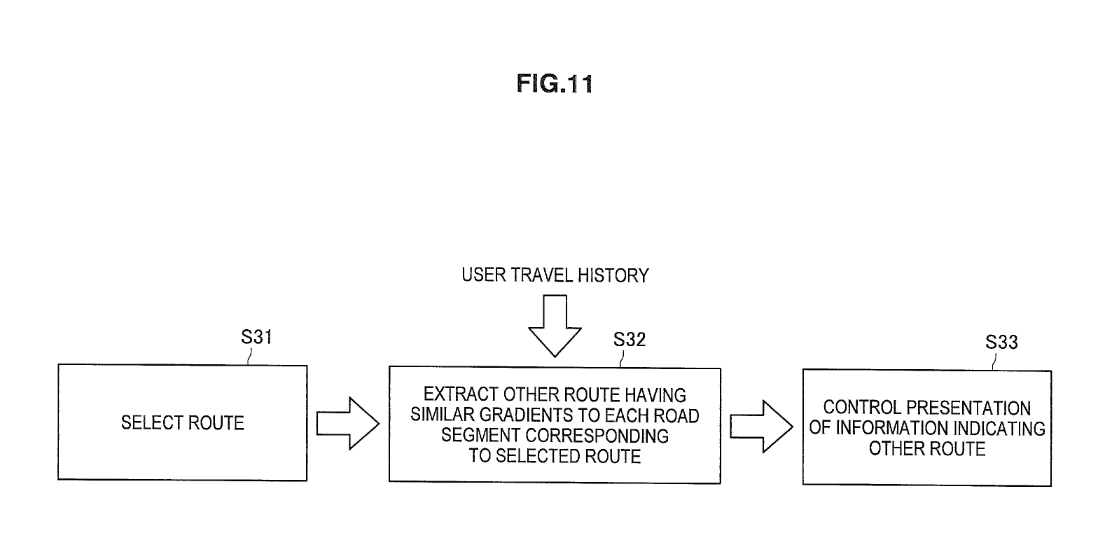

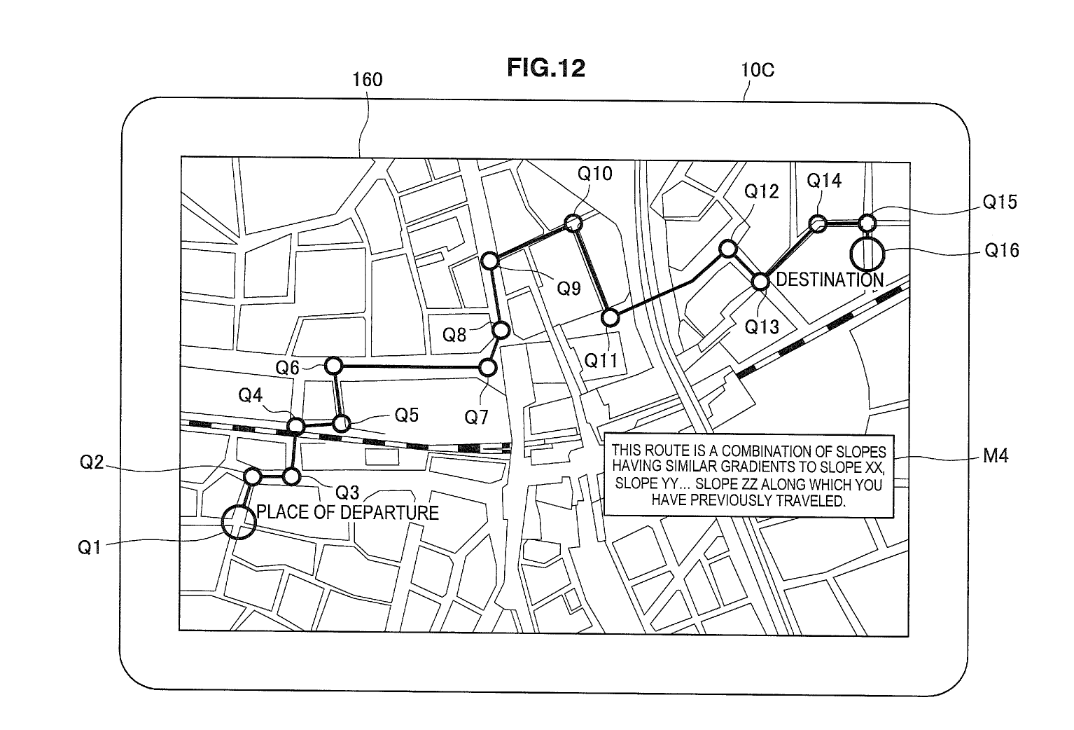

Next, an example of the functions of the presentation control device 10C according to the third embodiment of the present disclosure will be explained. FIG. 11 is a diagram showing the example of the functions of the presentation control device 10C according to the third embodiment of the present disclosure. Further, FIG. 12 is a diagram showing a display result due to control by the presentation control device 10C according to the third embodiment of the present disclosure.

As shown in FIG. 11, first, the route selection portion 112 selects a route from among one or a plurality of routes (step S31). The route selection can be performed similarly to the route selection according to the first embodiment. Next, the history acquisition portion 113 acquires the user travel history and, based on the user travel history, the extraction portion 114C extracts another route having gradients similar to each of road segments corresponding to a target route (step S32).

The target route corresponds to a route from the place of departure to the destination of the user, for example. For example, when the target route and the other route are each formed of sequentially continuous road segments from the first road segment to an nth road segment, the extraction portion 114C extracts the other route when the gradients of all the road segments corresponding to the sequence are similar for the target route and the other route.

Next, the presentation control portion 115C controls presentation of information indicating the other route extracted by the extraction portion 114C (step S33). For example, the presentation control portion 115C may control presentation of each of road segment names corresponding to names of each of the road segments forming the other route. However, the information indicating the other route is not limited to the names of each of the road segments. For example, the information indicating the other route may be identifiers for each of the road segments forming the other route.

In FIG. 12, an example is shown in which the extraction portion 114C extracts, from the user travel history, the other route that is formed, respectively, of road segments each having a similar gradient to the first road segment (from the point Q1 to the point Q2), the second road segment (from the point Q2 to the point Q3) and so on up to the fifteenth road segment (from the point Q15 to the point Q16). In this example, the presentation control portion 115C controls display of a message M4 relating to the extracted other route that reads: “This route is a combination of slopes having similar gradients to slope XX, slope YY . . . slope ZZ along which you have previously traveled.” The information “XX,” “YY” and “ZZ” included in the message M4 can be acquired, respectively, from the “road segment name” included in the road information, for example.

The example of the functions of the presentation control device 10C according to the third embodiment of the present disclosure is explained above. According to the example of the functions, the extraction portion 114C extracts the other route having gradients that are similar to each of the road segments corresponding to the target route, and the presentation control portion 115C can control presentation of the information indicating the other route extracted by the extraction portion 114C. As a result, it is possible to easily get a real feel for the extent of the gradients of the road segments, for the gradients of the whole route. It should be noted that the extraction portion 114C may extract the other route when the other route has distances that are, additionally, also similar to each of the road segments corresponding to the target route.

The third embodiment of the present disclosure is explained in detail above.

### 5. Conclusion

As described above, according to the embodiments of the present disclosure, it is possible to realize a presentation control device that is provided with an extraction portion and a presentation control portion, in which the extraction portion extracts a road segment having a similar gradient to a target road segment based on a user travel history, and the presentation control portion controls presentation of information indicating the road segment extracted by the extraction portion. According to this configuration, the technology is realized by which it is possible for the user to easily get a real feel for the extent of the gradient of the road segment.

Note that exemplary embodiments of the present disclosure have been explained in detail with reference to the appended drawings, but the technical scope of the present disclosure is not limited to the above-described examples. It should be understood by those skilled in the art that various modifications, combinations, sub-combinations and alterations may occur depending on design requirements and other factors insofar as they are within the scope of the appended claims or the equivalents thereof.

For example, as it is necessary for the information presented by the output portion 160 to be perused by the user, it is assumed that the output portion 160 is provided in a terminal that can be perused by the user. Meanwhile, it is assumed that at least some or all of the route selection portion 112, the history acquisition portion 113, the extraction portion 114 and the presentation control portion 115 are provided in a server that is separate from the terminal. When the extraction portion 114 is provided in the server, for example, it is necessary for the server to transmit the information extracted by the extraction portion 114 to the terminal. In this case, the transmission by the server of the information extracted by the extraction portion 114 is included in the above-described control of the presentation of the information by the presentation control portion 115.

Further, in the above explanation, the example is given in which the position acquisition portion 111 acquires the current position of the user and the extraction portion 114A extracts the road segment based on, additionally, the distance from the current position of the user. In this example also, it is assumed that the position acquisition portion 111 is provided in the terminal held by the user, but the extraction portion 114A may be provided either in the terminal or in the server.

Thus, it is also possible to provide a position acquisition device that is provided with the position acquisition portion 111 that acquires the current position of the user. In this case, in the first embodiment of the present disclosure, the road segment having the gradient that is similar to the target road segment may be extracted by the extraction portion 114A based on the current position of the user and on the user travel history, and the control of the presentation of the information indicating the extracted road segment may be performed by the presentation control portion 115A.

Further, in the second embodiment of the present disclosure, the road segment having the gradient and the distance that are similar to the target road segment may be extracted by the extraction portion 114B based on the current position of the user and on the user travel history, and the control of the presentation of the information indicating the extracted road segment may be performed by the presentation control portion 115A.

Furthermore, each step in the operations of the presentation control device 10 of the present specification may not necessarily be processed chronologically in the order shown in the flowcharts. For example, each of the steps in the operations of the presentation control device 10 may be processed in an order that is different to that shown in the flowcharts, or may be processed in parallel.

Further, a program can be created that causes hardware built into a computer, such as a CPU, a ROM and a RAM etc., to execute functions similar to those of the configuration of the above-described presentation control device 10. It is also possible to provide a computer-readable storage medium that stores the program.

Additionally, the present technology may also be configured as below.

(1) A presentation control device including:

an extraction portion that extracts a road segment having a similar gradient to a target road segment based on a travel history of a user; and

a presentation control portion that controls presentation of information indicating the road segment extracted by the extraction portion.

(2) The presentation control device according to (1), wherein

the extraction portion extracts a road segment having, additionally, a similar distance to the target road segment.

(3) The presentation control device according to (1) or (2), wherein

the extraction portion extracts a road segment based on, additionally, a distance from a position that is registered in advance.

(4) The presentation control device according to any one of (1) to (3), wherein

the extraction portion extracts a road segment based on, additionally, a distance from a current position of the user.

(5) The presentation control device according to any one of (1) to (4), wherein

the extraction portion extracts a road segment based on, additionally, a frequency of passage of the user.

(6) The presentation control device according to (1), wherein

the extraction portion extracts another route having gradients that are similar to each of road segments corresponding to a target route, based on the travel history of the user, and

the presentation control portion controls presentation of information indicating the other route extracted by the extraction portion.

(7) A presentation control method including:

extracting a road segment having a similar gradient to a target road segment based on a travel history of a user; and

controlling presentation of information indicating the extracted road segment.

(8) A program for causing a computer to function as a presentation control device including:

an extraction portion that extracts a road segment having a similar gradient to a target road segment based on a travel history of a user; and

a presentation control portion that controls presentation of information indicating the road segment extracted by the extraction portion.

(9) A computer-readable storage medium storing a program for causing a computer to function as a presentation control device including:

an extraction portion that extracts a road segment having a similar gradient to a target road segment based on a travel history of a user; and

a presentation control portion that controls presentation of information indicating the road segment extracted by the extraction portion.

(10) A position acquisition device including:

a position acquisition portion that acquires a current position of a user, wherein

a road segment having a similar gradient to a target road segment is extracted based on the current position and on a travel history of the user, and presentation of information indicating the extracted road segment is controlled.

The present disclosure contains subject matter related to that disclosed in Japanese Priority Patent Application JP 2012-121556 filed in the Japan Patent Office on May 29, 2012, the entire content of which is hereby incorporated by reference.

What is claimed is:

1. A presentation control device comprising:
an extraction portion that extracts a road segment having a similar gradient to a target road segment based on a travel history of a user; and
a presentation control portion that controls presentation of information indicating the road segment extracted by the extraction portion.

2. The presentation control device according to claim 1, wherein
the extraction portion extracts a road segment having, additionally, a similar distance to the target road segment.

3. The presentation control device according to claim 1, wherein
the extraction portion extracts a road segment based on, additionally, a distance from a position that is registered in advance.

4. The presentation control device according to claim 1, wherein
the extraction portion extracts a road segment based on, additionally, a distance from a current position of the user.

5. The presentation control device according to claim 1, wherein
the extraction portion extracts a road segment based on, additionally, a frequency of passage of the user.

6. The presentation control device according to claim 1, wherein
the extraction portion extracts another route having gradients that are similar to each of road segments corresponding to a target route, based on the travel history of the user, and
the presentation control portion controls presentation of information indicating the other route extracted by the extraction portion.

7. A presentation control method comprising:
extracting a road segment having a similar gradient to a target road segment based on a travel history of a user; and
controlling presentation of information indicating the extracted road segment.

8. A program for causing a computer to function as a presentation control device including:
an extraction portion that extracts a road segment having a similar gradient to a target road segment based on a travel history of a user; and
a presentation control portion that controls presentation of information indicating the road segment extracted by the extraction portion.

9. A computer-readable storage medium storing a program for causing a computer to function as a presentation control device including:
an extraction portion that extracts a road segment having a similar gradient to a target road segment based on a travel history of a user; and
a presentation control portion that controls presentation of information indicating the road segment extracted by the extraction portion.

10. A position acquisition device comprising:
a position acquisition portion that acquires a current position of a user, wherein
a road segment having a similar gradient to a target road segment is extracted based on the current position and on a travel history of the user, and presentation of information indicating the extracted road segment is controlled.
